(19) United States
(12) Patent Application Publication
(10) Pub. No.: US 2018/0370205 A1
(43) Pub. Date: Dec. 27, 2018

(54) INFRARED ABSORBING ADHESIVE FILMS AND RELATED METHODS

(71) Applicant: 3M INNOVATIVE PROPERTIES COMPANY, St. Paul, MN (US)

(72) Inventors: Przemyslaw P. Markowicz, Woodbury, MN (US); Neeraj Sharma, Woodbury, MN (US); Jeremy K. Larsen, Farmington, MN (US); Jeffrey O. Emslander, City of Grant, MN (US); Jung-Sheng Wu, Woodbury, MN (US); Richard G. Anderson, Lenoir, NC (US); Frank C. Piras, Sanford, NC (US)

(21) Appl. No.: 16/064,657

(22) PCT Filed: Dec. 22, 2016
(86) PCT No.: PCT/US2016/068195

§ 371 Date: Jun. 21, 2018

Related U.S. Application Data
(60) Provisional application No. 62/273,074, filed on Dec. 30, 2015.

(51) Int. Cl. B32B 27/20; B32B 27/32; B32B 7/12; C08K 3/22; C08K 3/34; B23K 26/18

(52) U.S. Cl. CPC B32B 27/20; B32B 27/32; B32B 7/12; B23K 2103/172; C08K 3/34; B23K 26/18; C08K 2003/2258; C08K 3/22

(57) ABSTRACT

Provided are adhesive-backed films and related methods useful in laser cutting a substrate protected by an adhesive-backed film. The adhesive-backed film includes a base layer comprised of a polymer and having opposing first and second major surfaces and an adhesive layer comprising a pressure-sensitive adhesive directly or indirectly coupled to the second major surface. An infrared absorber is present in one or both of the polymer and the pressure-sensitive adhesive, and the adhesive-backed film is sufficiently transparent to enable visual inspection of a surface having the adhesive-backed film disposed thereon.

### CROSS REFERENCE TO RELATED APPLICATION

This application claims the benefit of U.S. Provisional Patent Application No. 62/273,074, filed Dec. 30, 2015, the disclosure of which is incorporated by reference herein in its entirety.

### FIELD OF THE INVENTION

Provided are adhesive-backed films, and in particular adhesive-backed films for use in laser cutting operations.

### BACKGROUND

Laser cutting is a non-contact process where a laser beam is used to cut through a material. Laser cutting is most common in industrial manufacturing applications, and can be used to convert a wide range of materials, including metals, plastics, and ceramics. This technology is commonly used, for example, in the medical, automotive, electronics, aerospace, and solar industries.

Laser cutting generally involves directing the output of a high-power laser through optical elements onto the substrate to be cut. A computer can be used to control the relative position and orientation of the substrate and the laser beam according to a pre-determined cutting pattern. The area of the substrate hit by the laser beam melts, burns, vaporizes away, or is blown away by a jet of gas, leaving an edge with a high-quality surface finish. Industrial laser cutters are used to cut flat-sheet material as well as structural and piping materials.

Advantageously, a focused laser beam can provide very precise and dimensionally accurate cuts. A further advantage of laser cutting over mechanical cutting is easier work-holding and reduced contamination of workpiece, since there is no cutting edge which can contaminate, or become contaminated by, the material being cut. The precision and accuracy of the cuts can also be very consistent because the laser beam does not wear during the process. Using a laser also reduces the chance of warping the material as it is being cut, as laser systems have a small heat-affected zone. Some materials are difficult or impossible to cut by more traditional means.

The market for CO₂ laser-based metal processing has become quite mature and industrial players are quickly transitioning to fiber laser systems based on near-infrared (“NIR”) radiation. Many U.S. laser original equipment manufacturers (“OEMs”) no longer offer the older CO₂ laser technology. Fiber lasers are often preferred because they process at faster speeds and use less energy than CO₂ laser-based systems.

### SUMMARY

Manufacturers benefit from avoiding surface damage during part handling whenever possible. At the same time, however, any surface defects should be made visible early in the manufacturing process, allowing the defective part to be fixed or replaced before it is assembled with other parts. Both of these objectives can be achieved, in theory, using a transparent, protective film disposed on the substrate that can be cut cleanly with the same laser used to cut the substrate.

Such a solution is not presently available for fiber lasers. Current protective film offerings that can be used with fiber lasers are opaque in the visible range, making visual inspection through the film impossible. This can also prevent surface indicia on the substrate from being used for optical registration in, for example, a manufacturing or conversion process. Transparent, protective adhesive-backed films for CO₂ lasers are available, but these films do not work with 1 □m lasers (or fiber lasers) because they do not sufficiently absorb light over NIR wavelengths.

Provided herein are transparent, adhesive-backed protective films that can be cut effectively using fiber lasers, protect the substrate from scratches, and also enable surface inspection without the necessity of removing the film. This would save time and improve throughput by eliminating defective parts early in the production process. This is an improvement over opaque protective tapes, which allow inspection only after all production steps are completed and the tape is removed.

The provided films incorporate selected absorbers and additives/synergists useful for making transparent protective tapes for fiber laser processing. Useful NIR absorbers include metal-doped and self-doped tungsten oxides (e.g., WO₃₋ₓ, WO, and Cs⁺ ion doped WO) which exhibit high visible transparency, strong near-IR absorption, and thermal stability at extrusion temperatures.

In a first aspect, an adhesive-backed film is provided. The adhesive-backed film comprises: a base layer comprising a polymer and having opposing first and second major surfaces; and an adhesive layer comprising a pressure-sensitive adhesive disposed on the second major surface of the base layer; and an infrared absorber present in one or both of the polymer and the pressure-sensitive adhesive, the adhesive-backed film being sufficiently transparent to provide contact clarity with respect to a surface having the adhesive-backed film disposed thereon.

In a second aspect, a laminated substrate is provided comprising a substrate and the aforementioned adhesive-backed film at least partially adhered to the substrate.

In a third aspect, a method of laser cutting a substrate is provided comprising: adhering an aforementioned adhesive-backed film to an outer surface of the substrate, thereby providing a laminated substrate; and directing an infrared laser beam onto the laminated substrate to cut at least a portion of the outer surface, whereby the infrared laser beam causes shrinkage and/or removal of the adhesive-backed film extending over the outer surface away from the edges of the cut by a certain margin.

In a fourth aspect, a method of laser cutting a substrate is provided comprising: adhering to an outer surface of the substrate an adhesive-backed film to provide a laminated substrate, adhesive-backed film comprising a base layer having a major surface and an adhesive layer disposed on the major surface, wherein at least one of the base layer or adhesive layer contains an infrared absorber and wherein the adhesive-backed film is sufficiently translucent or transparent to visible light to provide contact clarity with respect to the outer surface; and directing an infrared laser beam onto the laminated substrate to cut along at least a portion of the outer surface whereby the laser beam causes areas of the adhesive-backed film extending over the outer surface to shrink away and/or become removed from the edges of the cut by a certain margin.

### BRIEF DESCRIPTION OF THE DRAWINGS

FIG. 1 is a side cross-sectional view of an adhesive-backed film according to one exemplary embodiment;

FIG. 2 is a side cross-sectional view of an adhesive-backed film according to another exemplary embodiment;

FIG. 3 is a side cross-sectional view of an adhesive-backed film according to still another exemplary embodiment;

FIG. 4 is a schematic of an exemplary laser cutting process using any of the aforementioned adhesive-backed films; and

FIGS. 5 and 6 are optical micrographs showing, in top view, sheet metal laminated to two different adhesive-backed films after being cut by a laser.

Repeated use of reference characters in the specification and drawings is intended to represent the same or analogous features or elements of the disclosure. It should be understood that numerous other modifications and embodiments can be devised by those skilled in the art, which fall within the scope and spirit of the principles of the disclosure. The figures may not be drawn to scale.

### Definitions

As used herein:

“infrared” refers to the portion of the electromagnetic spectrum extending from about 780 nm to about 1 mm (1,000,000 nm);

“near infrared” refers to the portion of the electromagnetic spectrum extending from about 780 nm to about 2,500 nm; and

“particle size” refers to the longest dimension of the particle.

### DETAILED DESCRIPTION

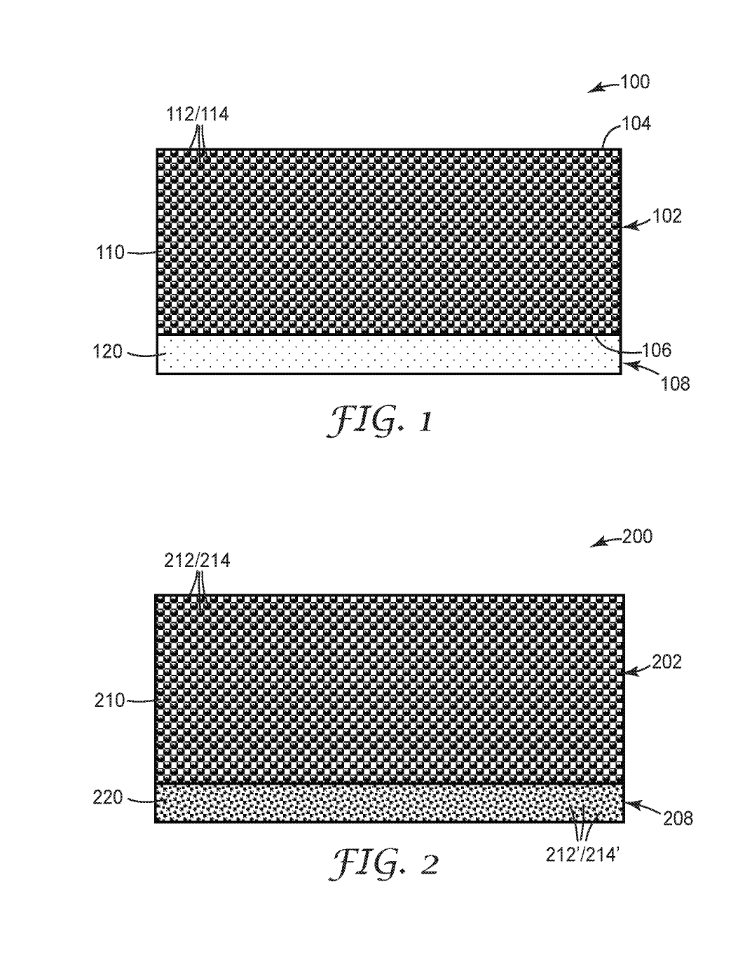

An adhesive-backed film according to a first embodiment is illustrated in FIG. 1 and hereinafter referred to by the numeral 100. The film 100 is a bilayer comprised of a base layer 102 having first and second major surfaces 104, 106, and an adhesive layer 108 extending across and contacting the second major surface 106 of the base layer 102. Each of the layers 102, 108 will be further examined in turn below.

In the embodiment shown, the base layer 102 is a continuous layer. The base layer 102 includes a matrix made from a polymer 110 and particles of an infrared absorber 112 embedded in the polymer 110.

The polymer 110 is preferably a flexible polymer that is transparent or translucent. The polymer 110 can be, for example, a polyolefin (e.g., polyethylene), polyurethane, polyamide, polyester, or polyvinyl acetate, or a blend or copolymer thereof.

Preferably, the infrared absorber 112 is a near-infrared absorber. Near-infrared absorbers include, for example, a reduced tungsten oxide or a tungsten oxide doped with some other metal. Useful metal-doped tungsten oxides include, but are not limited to, cesium tungsten oxide, sodium tungsten oxide, antimony tin oxide, and indium tin oxide.

The absorber particles can be either micrometer- or nanometer-scaled. For instance, they can be from 5 nm to 10 μm in size. They are, for instance, from 20 nm to 800 nm in size, for example from about 20 nm to about 300 nm or from about 20 nm to about 200 nm in size. In some embodiments, greater than 90 percent of the particles (by number) are within these ranges. Particle size is determined by scanning electron microscopy. A particle size of less than 300 nm is desired to achieve good transparency with minimal haze when the particles are incorporated into a suitable substrate.

Other near-infrared absorbers include near-infrared absorbing dyes that are soluble in the polymer and near-infrared absorbing pigments. Optionally, the infrared absorber 112 may be a mixture of two or more of the above absorbers.

The infrared absorber 112 generally displays a spectroscopic absorption curve with significant absorption at wavelengths within the infrared range of the electromagnetic spectrum, which extends from about 780 nm to about 2500 nm.

In some embodiments, the infrared absorber 112 displays an absorption of at least 10% (i.e., 90% transmission and scattering) at a wavelength ranging from 780 nm to 2500 nm, as measured along the thickness dimension of the adhesive-backed film. More preferably, the infrared absorber 112 displays an absorption of at least 30% at a wavelength ranging from 780 nm to 1100 nm, as measured along the thickness dimension of the adhesive-backed film. Most preferably, the infrared absorber 112 displays an absorption of at least 40% at a wavelength ranging from 1000 nm to 1100 nm, as measured along the thickness dimension of the adhesive-backed film.

The infrared absorber 112 is present in the base layer 102 in an amount sufficient to enable substantial localized melting or degradation of the polymer matrix. In an exemplary laser cutting process, this molten polymer is then immediately evacuated by means of a pressurized gas directed at the cutting zone. This type of laser cutting is sometimes referred to as fusion cutting. This method is not intended, however, to be limiting and other cutting methods (e.g., vaporization cutting, thermal stress cracking) may be alternatively used.

In some embodiments, the infrared absorber 112 is present in an amount of at least 0.1 percent, at least 0.2 percent, at least 0.3 percent, at least 0.4 percent, or at least 0.5 percent by volume relative to the overall volume of the base layer 102. In some embodiments, the infrared absorber 112 is present in an amount of up to 10 percent, up to 8 percent, up to 6 percent, up to 4 percent, or up to 3 percent by volume relative to the overall volume of the base layer 102.

The base layer 102 can advantageously contain one or more synergistic fillers 114 that are distinct from the infrared absorber 112. In a laser cutting process, mixing a synergistic filler 114 into the base layer 100 appears to cause areas of the adhesive-backed film 100 to retract and/or become removed from the vicinity of the laser beam as it cuts through the substrate coated with the adhesive-backed film 100. This in turn helps prevent molten or partially-molten polymer material from interfering with the cutting of the underlying substrate, which would otherwise occur if the synergistic filler 114 were not present.

Useful synergistic fillers 114 are heterogeneous, and yet display refractive properties that do not cause the adhesive-backed film 100, as a whole, to become opaque or otherwise prevent contact clarity—that is, clear, visual observation of the underlying substrate through the adhesive-backed film 100. This property generally depends on both the refractive index of the matrix (i.e., the polymer 110) and that of the synergistic fillers 114.

When transmitting light (such as visible light) through a heterogeneous dispersion, the degree of light scattering depends on the magnitude of the difference between the refractive index of a dispersed phase and the dispersion medium. With respect to the adhesive-backed film 100, a smaller difference in refractive index would produce improved clarity. In some embodiments, the refractive index of the material of the synergistic filler 114 differs (either positively or negatively) from the refractive index of the polymer by up to 0.8, up to 0.7, up to 0.5, up to 0.3, or up to 0.1 (in absolute terms). In the same or alternative embodiments, the material of the synergistic filler 114 can have an absolute refractive index of up to 2, up to 1.8, up to 1.7, up to 1.6, or up to 1.5 (in absolute terms).

Exemplary synergistic fillers 114 include talc, diatomaceous earth, nepheline syenite, calcium carbonate, glass bead, synthetic ceramic bead, metal oxides, metal hydroxides and carbonates, natural and synthetic clays, and combinations thereof.

Although not required, the synergistic filler 114 may also display some degree of infrared absorption. In some embodiments, the synergistic filler 114 displays an absorption of at least 5% at a wavelength ranging from 780 nm to 2500 nm, as measured along the thickness dimension of the adhesive-backed film. More preferably, the synergistic filler 114 displays an absorption of at least 10% at a wavelength ranging from 780 nm to 1100 nm, as measured along the thickness dimension of the adhesive-backed film. Most preferably, the synergistic filler 114 displays an absorption of at least 20% at a wavelength ranging from 780 nm to 1100 nm, as measured along the thickness dimension of the adhesive-backed film.

In some embodiments, the synergistic filler 114 is present in an amount of at least 0.5 percent, at least 0.75 percent, at least 1 percent, at least 1.5 percent, or at least 2.5 percent by volume relative to the overall volume of the base layer 102. In some embodiments, the synergistic filler 114 is present in an amount of up to 30 percent, up to 25 percent, up to 20 percent, up to 15 percent, or up to 10 percent by volume relative to the overall volume of the base layer 102.

The base layer 102 can have any reasonable thickness enabling the adhesive-backed film 100 to uniformly cover and adhere to a particular substrate at hand. The base layer 102 could have, for example, a thickness of at least 10 micrometers, at least 15 micrometers, at least 25 micrometers, at least 35 micrometers, or at least 50 micrometers. On the upper end, the base layer 102 could have a thickness of up to 200 micrometers, up to 150 micrometers, up to 125 micrometers, up to 115 micrometers, or up to 100 micrometers.

The adhesive layer 108 includes a pressure-sensitive adhesive 120. Pressure-sensitive adhesives are a distinct category of adhesives and a distinct category of thermoplastics, which in dry (solvent-free) form are aggressively, and permanently, tacky at room temperature. They firmly adhere to a variety of dissimilar surfaces upon mere contact without the need of more than finger or hand pressure. Pressure-sensitive adhesives require no activation by water, solvent, or heat to exert a strong adhesive holding force toward such materials as paper, cellophane, glass, wood, and metals. They are sufficiently cohesive and elastic in nature so that, despite their aggressive tackiness, they can be handled with the fingers and removed from smooth surfaces without leaving a residue. Pressure-sensitive adhesives can be quantitatively described using the “Dahlquist criteria” which maintains that the elastic modulus of these materials is less than 106 dynes/cm2 at room temperature (see, for example, Pocius, A.V., Adhesion & Adhesives: An Introduction, Hanser Publishers, New York, N.Y., First Edition, 1997).

Exemplary compositions for the pressure-sensitive adhesive 120 include, but are not limited to, acrylic pressure-sensitive adhesives, rubber pressure-sensitive adhesives, rubber-resin pressure-sensitive adhesives, vinyl alkyl ether pressure-sensitive adhesives, silicone pressure-sensitive adhesives, polyester pressure-sensitive adhesives, polyamide pressure-sensitive adhesives, urethane pressure-sensitive adhesives, fluorinated pressure-sensitive adhesives, epoxy pressure-sensitive adhesives, block copolymer-based pressure-sensitive adhesives and other known pressure-sensitive adhesives. In a preferred embodiment, acrylic pressure-sensitive adhesives are used. Each of the different pressure-sensitive adhesives can be used alone or in combination. The particular pressure-sensitive adhesives used are not critical, and examples could include emulsion pressure-sensitive adhesives, solvent-borne pressure-sensitive adhesives, photo-polymerizable pressure-sensitive adhesives and hot melt pressure-sensitive adhesives (i.e., hot melt extruded pressure-sensitive adhesives).

Acrylic pressure-sensitive adhesives include pressure-sensitive adhesives containing an acrylic polymer as a base polymer (or base resin). Though not so limited, the acrylic polymer can be prepared by subjecting to polymerization (or copolymerization) one or more alkyl (meth)acrylates as essential monomer components (main monomer components) and, where necessary, one or more monomers copolymerizable with the alkyl (meth)acrylates. Exemplary copolymerizable monomers include polar-group-containing monomers and multifunctional monomers. The polymerization can be performed, without limitation, according to any technique known in the art, such as ultraviolet polymerization, solution polymerization, or emulsion polymerization.

Alkyl (meth)acrylates for use as main monomer components of the acrylic polymer herein are alkyl (meth)acrylates each having a linear or branched-chain alkyl group, and examples include alkyl (meth)acrylates whose alkyl moiety has 1 to 20 carbon atoms, such as methyl (meth)acrylates, ethyl (meth)acrylates, propyl (meth)acrylates, isopropyl (meth)acrylates, butyl (meth)acrylates, isobutyl (meth)acrylates, s-butyl (meth)acrylates, t-butyl (meth)acrylates, pentyl (meth)acrylates, isopentyl (meth)acrylates, hexyl (meth)acrylates, heptyl (meth)acrylates, octyl (meth) acrylates, 2-ethylhexyl (meth) acrylates, isooctyl (meth)acrylates, nonyl (meth)acrylates, isononyl (meth)acrylates, decyl (meth)acrylates, isodecyl (meth)acrylates, undecyl (meth)acrylates, dodecyl (meth) acrylates, tridecyl (meth) acrylates, tetradecyl (meth) acrylates, pentadecyl (meth) acrylates, hexadecyl (meth)acrylates, heptadecyl (meth) acrylates, octadecyl (meth)acrylates, nonadecyl (meth)acrylates, and eicosyl (meth)acrylates. Among these, alkyl (meth)acrylates whose alkyl moiety has 2 to 14 carbon atoms are preferred, and alkyl (meth)acrylates whose alkyl moiety has 2 to 10 carbon atoms are more preferred.

As a primary monomer component of the acrylic polymer, the amount of alkyl (meth)acrylates is, in some embodiments, 60 percent by weight or more, and in other embodiments 80 percent by weight or more, based on the total amount of monomer components for constituting the acrylic polymer. The acrylic polymer may further contain, as monomer components, one or more copolymerizable monomers such as polar-group-containing monomers and multifunctional monomers. The presence of copolymerizable monomers as monomer components may, in some embodiments, provide the pressure-sensitive adhesive with improved adhesive strength to an adherend and/or a higher cohesive strength. Each of the different copolymerizable monomers can be used alone or in combination with others.

Exemplary polar-group-containing monomers include carboxyl-containing monomers such as (meth)acrylic acids, itaconic acid, maleic acid, fumaric acid, crotonic acid, and isocrotonic acid, along with anhydrides of them, such as maleic anhydride; hydroxyl-containing monomers including hydroxyalkyl (meth)acrylates such as hydroxyethyl (meth)acrylates, hydroxypropyl (meth) acrylates, and hydroxybutyl (meth)acrylates; amido-containing monomers such as acrylamide, methacrylamide, N,N-dimethyl(meth)acrylamides, N-methylol(meth)acrylamides, N-methoxymethyl(meth)-acrylamides, and N-butoxymethyl(meth)acrylamides; amino-containing monomers such as aminoethyl (meth)acrylates, dimethylaminoethyl (meth)acrylates, and t-butylaminoethyl (meth) acrylates; glycidyl-containing monomers such as glycidyl (meth)acrylates and methylglycidyl (meth)acrylates; cyano-containing monomers such as acrylonitrile and methacrylonitrile; heterocycle-containing vinyl monomers such as N-vinyl-2-pyrrolidone, (meth)acryloylmorpholines, N-vinylpyridine, N-vinylpiperidone, N-vinylpyrimidine, N-vinylpiperazine, N-vinylpyrrole, N-vinylimidazole, N-vinyloxazole, and N-vinylcaprolactam; alkoxyalkyl (meth)acrylate monomers such as methoxyethyl (meth)acrylates and ethoxyethyl (meth)acrylates; sulfo-containing monomers such as sodium vinylsulfonate; phosphate-containing monomers such as 2-hydroxyethylacryloyl phosphate; imido-containing monomers such as cyclohexylmaleimide and isopropylmaleimide; and isocyanate-containing monomers such as 2-methacryloyloxyethyl isocyanate. Of these polar-group-containing monomers, acrylic acid and other carboxyl-containing monomers, and anhydrides thereof, are preferred. The amount of polar-group-containing monomers present is typically 30 percent by weight or less (e.g., from 0.1 to 30 percent by weight), and preferably from 0.1 to 15 percent by weight, based on the total amount of monomer components in the acrylic polymer. Polar-group-containing monomers, if used in an amount of more than 30 percent by weight, may cause the acrylic pressure-sensitive adhesive to have an excessively high cohesive strength and thereby show insufficient tackiness. Conversely, polar-group-containing monomers, if used in an excessively small amount (e.g., less than 1 percent by weight based on the total amount of monomer components in the acrylic polymer) may not satisfactorily provide the acrylic pressure-sensitive adhesive with a sufficient cohesive strength and/or a sufficiently high shearing force.

Examples of the multifunctional monomers include hexanediol di(meth)acrylates, butanediol di(meth)acrylates, (poly)ethylene glycol di(meth)acrylates, (poly)propylene glycol di(meth)acrylates, neopentyl glycol di(meth)acrylates, pentaerythritol di(meth)acrylates, pentaerythritol tri(meth)acrylates, dipentaerythritol hexa(meth)acrylates, trimethyloipropane tri(meth)acrylates, tetramethylolmethane tri(meth)acrylates, allyl (meth)acrylates, vinyl (meth)acrylates, divinylbenzene, epoxy acrylates, polyester acrylates, and urethane acrylates. The amount of multifunctional monomers present is typically 2 percent by weight or less (e.g., from 0.01 to 2 percent by weight) and preferably 0.02 to 1 percent by weight, based on the total amount of monomer components in the acrylic polymer. Multifunctional monomers, if used in an amount of more than 2 percent by weight of the total amount of monomer components in the acrylic polymer, may cause the acrylic pressure-sensitive adhesive to have an excessively high cohesive strength, resulting in insufficient tackiness. Multifunctional monomers, if used in an excessively small amount (e.g., less than 0.01 percent by weight of the total amount of monomer components for constituting the acrylic polymer), may not provide the acrylic pressure-sensitive adhesive with a sufficient cohesive strength.

In addition to the polar-group-containing monomers and multifunctional monomers, exemplary copolymerizable monomers usable herein further include vinyl esters such as vinyl acetate and vinyl propionate; aromatic vinyl compounds such as styrene and vinyltoluene; olefins or dienes such as ethylene, butadiene, isoprene, and isobutylene; vinyl ethers such as vinyl alkyl ethers; and vinyl chloride. Exemplary copolymerizable monomers further include (meth)acrylates each having an alicyclic hydrocarbon group, such as cyclopentyl (meth)acrylates, cyclohexyl (meth)acrylates, and isobornyl (meth)acrylates.

The pressure-sensitive adhesive 120 may contain one or more suitable additives. Exemplary additives usable herein include silanes, tackifiers (e.g., rosin esters, terpenes, phenols, and aliphatic, aromatic, or mixtures of aliphatic and aromatic synthetic hydrocarbon resins), crosslinking agents (e.g., polyisocyanate compounds, silicone compounds, epoxy compounds, and alkyl-etherified melamine compounds), surfactants, plasticizers (other than physical blowing agents), nucleating agents (e.g., talc, silica, or TiO₂), fillers (e.g., glass or polymeric low-density microspheres), fibers, age inhibitors, antioxidants, ultraviolet-absorbers, antistatic agents, lubricants, pigments, dyes, reinforcing agents, hydrophobic or hydrophilic silica, calcium carbonate, toughening agents, flame retardants, finely ground polymeric particles (e.g., polyester, nylon, or polypropylene), stabilizers (e.g., UV stabilizers), colorants (e.g., dyes and pigments such as carbon black), and combinations thereof.

The pressure-sensitive adhesive 120 is preferably a removable pressure-sensitive adhesive; that is, one that is capable of being cleanly removed from a substrate to which it is adhered without leaving significant adhesive residue. The sub-class of pressure-sensitive adhesives that display removability from various substrates is described, for example, in U.S. Pat. No. 3,922,464 (Silver et al.), U.S. Pat. No. 4,645,711 (Winslow et al.), U.S. Pat. No. 5,116,676 (Winslow et al.), U.S. Pat. No. 5,663,241 (Takamatsu et al.), and U.S. Pat. No. 5,648,425 (Everaerts et al.).

Further details concerning pressure-sensitive adhesive compositions are described, for example, in U.S. Patent Publication No. 2015/0030839 (Satrijo et al.).

The dimensions of the adhesive layer 108 should be appropriate for its function but are otherwise not particularly restricted. The adhesive layer 108 could have, for example, a thickness of at least 1 micrometers, at least 3 micrometers, at least 5 micrometers, at least 8 micrometers, or at least 10 micrometers. On the upper end, the adhesive layer 108 could have a thickness of up to 100 micrometers, up to 75 micrometers, up to 50 micrometers, up to 35 micrometers, or up to 25 micrometers.

FIG. 2 shows an adhesive-backed film 200 according to another exemplary embodiment bearing many similarities to the adhesive-backed film 100, including a base layer 202 containing infrared absorber 212 and synergistic filler 214 and a coextensive adhesive layer 208. Aspects of the base layer 202 are analogous to those already discussed with respect to base layer 102 and shall not be repeated.

Unlike the prior embodiment, the adhesive layer 208 contains a pressure-sensitive adhesive 210 having an embedded infrared absorber 212′ and synergistic filler 214′.

The infrared absorber 212′ and synergistic filler 214′ desirably has physical and chemical properties discussed above, keeping in mind that some are defined relative to the matrix material in which they are dispersed. They can be made of materials different from those of the infrared absorber 212 and synergistic filler 214, respectively. The infrared absorber 212′ and synergistic filler 214′ may also be present in the same or different concentrations than those of respective infrared absorber 212 and synergistic filler 214 and/or be characterized by the same or different characteristic particle sizes and size distributions.

Because a laser beam transmitted through the adhesive-backed film 200 would pass through both the base layer 202 and the adhesive layer 208, the loading of the infrared absorbers 212, 212′ and synergistic fillers 214, 214′ should take into account the cumulative volume of the layers, and particularly so when the adhesive-backed film 200 is relatively thin.

In some embodiments, the total amount of infrared absorber 212, 212′ is present in an amount of at least 0.1 percent, at least 0.2 percent, at least 0.3 percent, at least 0.4 percent, or at least 0.5 percent by volume relative to the overall (i.e., combined) volume of the base layer 202 and the adhesive layer 208. In some embodiments, the total amount of infrared absorber 212, 212′ is present in an amount of up to 10 percent, up to 8 percent, up to 6 percent, up to 4 percent, or up to 3 percent by volume relative to the overall volume of the base layer 202 and the adhesive layer 208.

In some embodiments, the total amount of synergistic filler 214, 214′ is present in an amount of at least 0.5 percent, at least 0.75 percent, at least 1 percent, at least 1.5 percent, or at least 2.5 percent by volume relative to the overall volume of the base layer 202 and the adhesive layer 208. In some embodiments, the total amount of synergistic filler 214, 214′ is present in an amount of up to 30 percent, up to 25 percent, up to 20 percent, up to 15 percent, or up to 10 percent by volume relative to the overall volume of the base layer 202 and the adhesive layer 208.

Optionally, the adhesive layer 208 may include only one, but not both, of the infrared absorber 212′ and synergistic filler 214′.

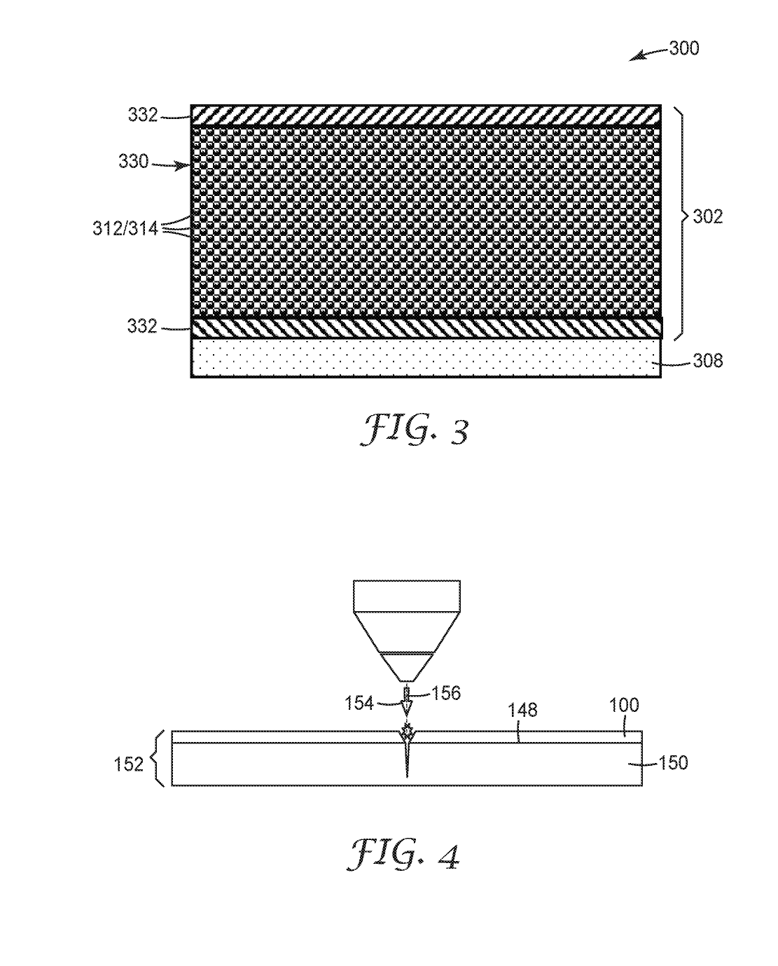

FIG. 3 shows a third exemplary adhesive-backed film 300 akin to the adhesive-backed film 100, in which a base layer 302 is disposed on an adhesive layer 308. In this case, however, the base layer 302 itself has a multi-layered structure. As shown, the base layer 302 has a core layer 330 disposed between a pair of discrete skin layers 332. As shown, each of these layers is solid and continuous.

In this embodiment, the core layer 330 contains an infrared absorber 312 and synergistic filler 314, while each skin layer 332 lacks either an infrared absorber or synergistic filler. The skin layers 332 can serve any of a number of useful purposes. For example, the skin layer 332 can acts a physical barrier that better secures the fillers within the adhesive-backed film 300. Since one of the skin layers 332 is exposed, the skin layer 332 can be advantageously made from a polymer or polymer composite material that has enhanced scratch resistance. The skin layers 332 could also be formulated to facilitate manufacturing, web handling, and/or storage of the adhesive-backed film 300.

The base layer 302 may include further layers (e.g., tie layers, primer layers, printed indicia, or additional skin layers) not explicitly shown in FIG. 3 without materially impairing the function of the adhesive-backed film 300. Additional features, options and advantages relating to the adhesive-backed film 300 have been previously described and shall not be repeated.

It is further appreciated that any of the aforementioned adhesive-backed films 100, 200, 300 may contain one or more additional layers for purposes known in the art. To facilitate user handling of the product, for example, any of the adhesive-backed films 100, 200, 300 could further include a release liner that disposed on the exposed major surface of its respective adhesive layer 108, 208, 308 and stripped off prior to use.

The provided adhesive-backed films are not restricted to use on any particular substrate. They are most advantageously applied, however, to a sheet metal substrate to be cut using a laser in a manufacturing process. Particular applications include the manufacture of stainless steel appliances in which the manufacturer desires to protect fabricated sheet metal parts from surface damage during handling. In certain applications, it is further desirable to retain the protective adhesive-backed film on the substrate even after the appliance is sold to a consumer. The film can then be peeled away and discarded by the consumer.

The cutting laser is preferably a fiber laser operating at a wavelength in the NIR spectrum range. For example, the NIR laser beam can have a wavelength of at least 780 nm, at least 800 nm, at least 850 nm, at least 900 nm, or at least 1000 nm. The NIR laser beam can have a wavelength of up to 2500 nm, up to 2250 nm, up to 2000 nm, up to 1500 nm, or up to 1100 nm.

A major technical advantage provided by the disclosed adhesive-backed films is its optical clarity when placed in contact with a substrate, or “contact clarity.” This allows an operator to visually inspect the surface of the underlying substrate (e.g., sheet metal) without need to remove the film. This allows defects in the metal parts to be detected and corrected early in the production process. With opaque protective films, inspection is possible only after all production steps are carried out and the film is removed.

FIG. 4 shows an exemplary method of laser cutting a substrate 150. In this figure, the adhesive-backed film 100 is shown adhered to an outer surface 148 of the substrate 150 to provide a laminated article 152. An infrared laser beam 156 is directed onto the laminated article 152 to cut through at least a portion of the outer surface 148 while a stream of pressurized gas 154 (such as nitrogen) is simultaneously directed at the cutting site to clear away debris. Generally, the laser beam 156 cuts entirely through the substrate 150, but it may be desired in some cases to only engrave the substrate 150. The presence of synergistic filler in the adhesive-backed film 100 causes the laser beam 156 to shrink and/or remove areas of the adhesive-backed film 100 extending over the outer surface within a certain margin of the edges of the cut, resulting in a cleaner and more efficient cutting operation. Notably, the degree of shrinkage or removal is also a function of the concentration of the absorber in the film.

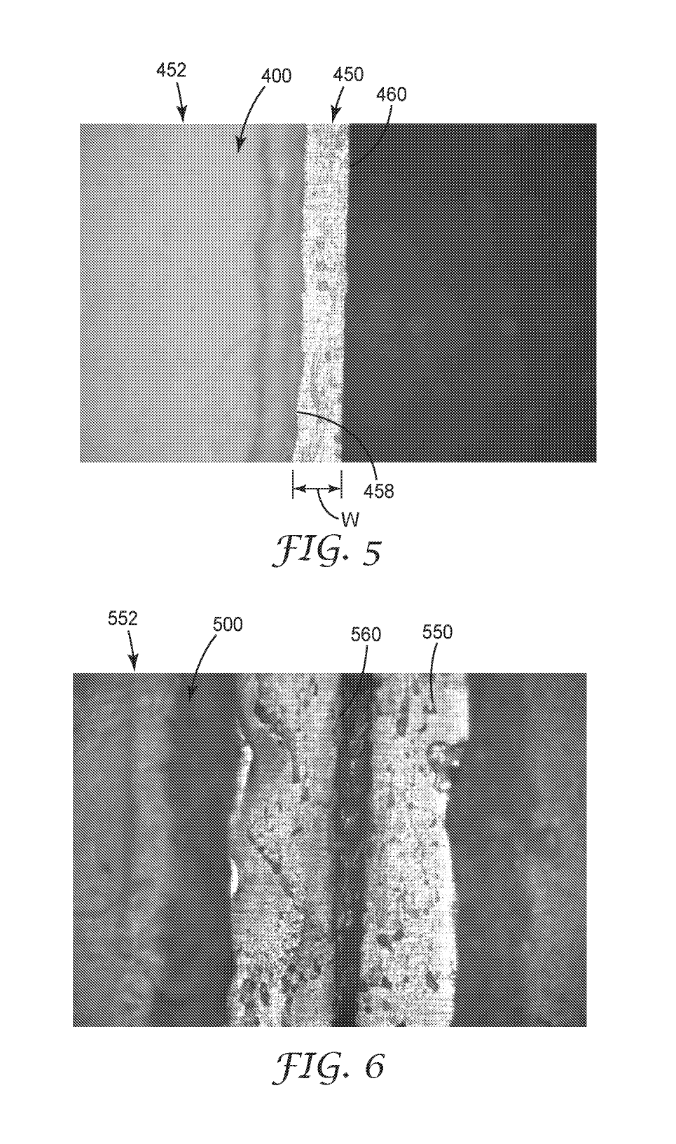

This phenomenon is evidenced by the micrographs of FIG. 5, which shows a view of laminated sheet metal stock 452 perpendicular to the plane of the laminate after cutting with an NIR laser. The depicted laminated sheet metal stock 452 includes sheet metal 450 with adhesive-backed film 400 extending partially over the sheet metal 450. As shown, the laminated substrate 452 displays film edge 458 and a cut edge 460. The cut edge 460, was defined by the path of the laser beam, is notably sharp and well-defined. The intermediate space between the film edge 458 and the cut edge 460 represents the margin along the outer surfaces of the sheet metal 450 over which the film shrinks away or becomes removed from the cut edge 460.

The margin over which the film shrinks away from, or otherwise becomes removed from, the outer surface of the substrate can have an average width “W” of at least 20 micrometers, at least 35 micrometers, at least 50 micrometers, at least 65 micrometers, or at least 80 micrometers. The width “W” could be up to 1 millimeter, up to 500 micrometers, up to 300 micrometers, up to 250 micrometers, up to 200 micrometers, up to 150 micrometers, up to 100 micrometers, or up to 50 micrometers.

The result shown in FIG. 5 can be contrasted with that of FIG. 6, in which an adhesive-backed film 500 was disposed on sheet metal 550 and then cut using an NIR mm laser under the same conditions used to produce the cut edge 460 of FIG. 5. The sheet metal 550 displayed significant melting and re-solidification in the vicinity of the cut edge 560 such that the laser only partially penetrated the sheet metal 550, without cutting entirely through it.

While not intended to be exhaustive, further embodiments of the adhesive-backed films and related methods are enumerated as follows:

Embodiment 1 is an adhesive-backed film comprising: a base layer comprising a polymer and having opposing first and second major surfaces; and an adhesive layer comprising a pressure-sensitive adhesive disposed on the second major surface of the base layer; and an infrared absorber present in one or both of the polymer and the pressure-sensitive adhesive, the adhesive-backed film being sufficiently transparent to provide contact clarity with respect to a surface having the adhesive-backed film disposed thereon.

Embodiment 2 is the adhesive-backed film of embodiment 1, wherein the infrared absorber is a near-infrared absorber.

Embodiment 3 is the adhesive-backed film of embodiment 2, wherein the near-infrared absorber comprises a metal-doped tungsten oxide or a reduced tungsten oxide.

Embodiment 4 is the adhesive-backed film of embodiment 3, wherein the metal-doped tungsten oxide comprises one or more of cesium tungsten oxide, sodium tungsten oxide, antimony tin oxide, and indium tin oxide.

Embodiment 5 is the adhesive-backed film of any one of embodiments 2-4, wherein the near-infrared absorber comprises a near-infrared absorbing dye or near-infrared absorbing pigment.

Embodiment 6 is the adhesive-backed film of any one of embodiments 1-5, wherein the infrared absorber displays an absorption of at least 10% at a wavelength of from 780 nm to 2500 nm along the thickness dimension of the adhesive-backed film.

Embodiment 7 is the adhesive-backed film of embodiment 6, wherein the infrared absorber displays an absorption of at least 30% at a wavelength of from 780 nm to 1100 nm along the thickness dimension of the adhesive-backed film.

Embodiment 8 is the adhesive-backed film of embodiment 7, wherein the infrared absorber displays an absorption of at least 40% at a wavelength of from 1000 nm to 1100 nm along the thickness dimension of the adhesive-backed film.

Embodiment 9 is the adhesive-backed film of any one of embodiments 1-8, wherein the polymer comprises one or more of a polyolefin, polyurethane, polyamide, polyester, vinyl acetate, and blends and copolymers thereof.

Embodiment 10 is the adhesive-backed film of embodiment 9, wherein the polymer comprises polyethylene.

Embodiment 11 is the adhesive-backed film of any one of embodiments 1-9, wherein the infrared absorber is present in an amount of from 0.1 percent to 10 percent by volume relative to the overall volume of the base layer and the adhesive layer.

Embodiment 12 is the adhesive-backed film of embodiment 11, wherein the infrared absorber is present in an amount of from 0.3 percent to 6 percent by volume relative to the overall volume of the base layer and the adhesive layer.

Embodiment 13 is the adhesive-backed film of embodiment 12, wherein the infrared absorber is present in an amount of from 0.5 percent to 3 percent by volume relative to the overall volume of the base layer and the adhesive layer.

Embodiment 14 is the adhesive-backed film of any one of embodiments 1-13, wherein either the base layer or the adhesive layer further comprises a synergistic filler having a refractive index of up to 2.

Embodiment 15 is the adhesive-backed film of embodiment 14, wherein the synergistic filler has a refractive index of up to 1.7.

Embodiment 16 is the adhesive-backed film of embodiment 15, wherein the synergistic filler has a refractive index of up to 1.55.

Embodiment 17 is the adhesive-backed film of any one of embodiments 14-16, wherein the synergistic filler comprises one or more of talc, diatomaceous earth, nepheline syenite, calcium carbonate, glass bead, synthetic ceramic bead, metal oxides, metal hydroxides and carbonates, and natural and synthetic clays.

Embodiment 18 is the adhesive-backed film of any one of embodiments 14-17, wherein the synergistic filler displays an absorption of at least 5% at a wavelength of from 780 nm to 2500 nm along the thickness dimension of the adhesive-backed film.

Embodiment 19 is the adhesive-backed film of embodiment 18, wherein the synergistic filler displays an absorption of at least 10% at a wavelength of from 780 nm to 1100 nm along the thickness dimension of the adhesive-backed film.

Embodiment 20 is the adhesive-backed film of embodiment 19, wherein the synergistic filler displays an absorption of at least 20% at a wavelength of from 780 nm to 1100 nm along the thickness dimension of the adhesive-backed film.

Embodiment 21 is the adhesive-backed film of any one of embodiments 14-20, wherein the synergistic filler is present in an amount of from 0.5 percent to 30 percent by volume relative to the overall volume of the base layer and the adhesive layer.

Embodiment 22 is the adhesive-backed film of embodiment 21, wherein the synergistic filler is present in an amount of from 1 percent to 20 percent by volume relative to the overall volume of the base layer and the adhesive layer.

Embodiment 23 is the adhesive-backed film of embodiment 22, wherein the synergistic filler is present in an amount of from 2.5 percent to 10 percent by volume relative to the overall volume of the base layer and the adhesive layer.

Embodiment 24 is the adhesive-backed film of any one of embodiments 14-23, wherein the synergistic filler is present in the base layer and the refractive index differs from that of the polymer by up to 0.8.

Embodiment 25 is the adhesive-backed film of embodiment 24, wherein the refractive index differs from that of the polymer by up to 0.5.

Embodiment 26 is the adhesive-backed film of embodiment 25, wherein the refractive index differs from that of the polymer by up to 0.1.

Embodiment 27 is the adhesive-backed film of any one of embodiments 14-26, wherein the synergistic filler is present in the adhesive layer and the refractive index differs from that of the pressure-sensitive adhesive by up to 0.8.

Embodiment 28 is the adhesive-backed film of embodiment 27, wherein the refractive index differs from that of the pressure-sensitive adhesive by up to 0.5.

Embodiment 29 is the adhesive-backed film of embodiment 28, wherein the refractive index differs from that of the pressure-sensitive adhesive by up to 0.1.

Embodiment 30 is the adhesive-backed film of any one of embodiments 1-29, wherein the pressure-sensitive adhesive comprises an acrylic pressure-sensitive adhesive.

Embodiment 31 is the adhesive-backed film of any one of embodiments 1-29, wherein the pressure-sensitive adhesive comprises a rubber-based pressure-sensitive adhesive.

Embodiment 32 is the adhesive-backed film of any one of embodiments 1-31, wherein the adhesive layer comprises a removable pressure-sensitive adhesive.

Embodiment 33 is the adhesive-backed film of any one of embodiments 1-32, wherein the base layer has a thickness of from 10 micrometers to 200 micrometers.

Embodiment 34 is the adhesive-backed film of embodiment 33, wherein the base layer has a thickness of from 25 micrometers to 125 micrometers.

Embodiment 35 is the adhesive-backed film of embodiment 34, wherein the base layer has a thickness of from 50 micrometers to 100 micrometers.

Embodiment 36 is the adhesive-backed film of any one of embodiments 1-35, wherein the adhesive layer has a thickness of from 1 micrometers to 100 micrometers.

Embodiment 37 is the adhesive-backed film of embodiment 36, wherein the adhesive layer has a thickness of from 5 micrometers to 50 micrometers.

Embodiment 38 is the adhesive-backed film of embodiment 37, wherein the adhesive layer has a thickness of from 10 micrometers to 30 micrometers.

Embodiment 39 is the adhesive-backed film of any one of embodiments 1-38, wherein the polymer is a first polymer and the base layer comprises a core layer comprising the first polymer disposed between a pair of skin layers, each skin layer comprising a second polymer.

Embodiment 40 is the adhesive-backed film of embodiment 39, wherein each skin layer further comprises an infrared absorber present in the second polymer.

Embodiment 41 is the adhesive-backed film of embodiment 39, wherein each of the skin layers substantially lacks any infrared absorber.

Embodiment 42 is the adhesive-backed film of any one of embodiments 39-41, wherein each of the skin layers further comprises a mineral filler that increases the scratch resistance of the adhesive-backed film.

Embodiment 43 is a laminated substrate comprising a substrate and the adhesive-backed film of any one of embodiments 1-42 at least partially adhered to the substrate.

Embodiment 44 is a method of laser cutting a substrate comprising: adhering an adhesive-backed film of any one of embodiments 1-42 to an outer surface of the substrate, thereby providing a laminated substrate; and directing an infrared laser beam onto the laminated substrate to cut at least a portion of the outer surface, whereby the infrared laser beam induces areas of the adhesive-backed film extending over the outer surface to shrink away and/or become removed from the edges of the cut by a certain margin.

Embodiment 45 is the method of embodiment 44, wherein the infrared laser beam is a near-infrared laser beam.

Embodiment 46 is the method of embodiment 45, wherein the near-infrared laser beam has a wavelength of from 780 nm to 2500 nm.

Embodiment 47 is the method of embodiment 46, wherein the near-infrared laser beam has a wavelength of from 850 nm to 2000 nm.

Embodiment 48 is the method of embodiment 47, wherein the near-infrared laser beam has a wavelength of from 1000 nm to 1100 nm.

Embodiment 49 is a method of laser cutting a substrate comprising: adhering to an outer surface of the substrate an adhesive-backed film to provide a laminated substrate, adhesive-backed film comprising a base layer having a major surface and an adhesive layer disposed on the major surface, wherein at least one of the base layer or adhesive layer contains an infrared absorber and wherein the adhesive-backed film is sufficiently translucent or transparent to visible light to provide contact clarity with respect to the outer surface; and directing an infrared laser beam onto the laminated substrate to cut along at least a portion of the outer surface whereby the laser beam causes areas of the adhesive-backed film extending over the outer surface to shrink away and/or become removed from the edges of the cut by a certain margin.

Embodiment 50 is the method of any one of embodiments 44-49, wherein directing the infrared laser beam onto the laminated substrate causes the adhesive-backed film to be spaced away from the cut by a margin width of at least 20 micrometers along the outer surface.

Embodiment 51 is the method of embodiment 50, wherein directing the infrared laser beam onto the laminated substrate causes the adhesive-backed film to be spaced away from the cut by a margin width of at least 50 micrometers along the outer surface.

Embodiment 52 is the method of embodiment 51, wherein directing the infrared laser beam onto the laminated substrate causes the adhesive-backed film to be spaced away from the cut by a margin width of at least 80 micrometers along the outer surface.

Embodiment 53 is the method of any one of embodiments 44-52, wherein removal of the adhesive-backed film is facilitated by a gas flow directed at the laminated substrate.

Embodiment 54 is the method of any one of embodiments 44-53, further comprising peeling a remainder of the adhesive-backed film away from the outer surface of the substrate after cutting the outer surface.

Embodiment 55 is the method of embodiment 54, wherein areas of the outer surface from which the adhesive-backed film was peeled away display no residual adhesive.

### EXAMPLES

Objects and advantages of this disclosure are further illustrated by the following non-limiting examples, but the particular materials and amounts thereof recited in these examples, as well as other conditions and details, should not be construed to unduly limit this disclosure.

All parts, percentages, ratios, etc. in the examples and the rest of the specification are by weight, unless noted otherwise. The reagents used were obtained from the specified sources and used as such without further purification unless otherwise noted.

### Materials

Table of Abbreviations

| Abbreviation or | |
|---|---|
| Trade Designation | Description |
| Cesium Tungsten | IR absorbing dispersion containing YMF-02A cesium tungsten oxide |
| Oxide (“CWO”) | nanoparticles obtained from Sumitomo Metal and Mining Company, Japan |
| LDPE-1 | Low Density Polyethylene, that is commercially available as NA21700 |
| | from Equistar Chemicals, LP (Houston, TX) |
| ABC-5000PB | 50 wt % talc in polyethylene available from Polyfil Corporation |
| | (Rockaway, NJ) |
| ABC-5000 | Antiblock concentrate available from Polyfil Corporation (Rockaway, NJ) |
| ABC-500HC | Antiblock concentrate available from Polyfil Corporation (Rockaway, NJ) |
| Titanium Dioxide | White titanium dioxide color concentrate #11937 available from |
| | Standridge Color Corporation (Social Circle, GA) |
| Carbon Black | Carbon black concentrate available from PolyOne, (Avon Lake, OH) |
| Tungsten Blue | Tungsten blue oxide powder available from Global Tungsten and Powders |
| Oxide (“WO”) | (Towanda, PA) |
| SOLPLUS D-510 | 100% active polymeric dispersant that is commercially available from The |
| | Lubrizol Corporation (Brecksville, OH) |
| SOLSPERSE M389 | Hyperdispersant that is commercially available from The Lubrizol |
| | Corporation (Cleveland, OH) |
| MEK | Ethyl methyl ketone (2-butanone) commercially available from EMD |
| | Millipore Corporation (Billerica, MA) |
| 3M PHOTO | Spray adhesive commercially available from 3M Company (St. Paul, MN) |
| MOUNT Adhesive | |
| NOVACEL | Fiber laser protective tape available from Novacel Inc., Palmer, MA |
| 4228REF | |

### IR Absorber/Synergist Content Estimation

The IR absorber/synergist content was estimated by calcining the masterbatch or extruded film sample in a porcelain crucible at 700° C. for 2 h and weighing the residual material.

### Preparatory Example 1: Tungsten Blue Oxide Dispersion

360 g Tungsten Blue Oxide (“WO”) powder was combined with 180 g SOLPLUS D510 and 1440 g MEK in a DISPERMAT CN-10 laboratory high-shear disperser (BYK-Gardner USA, Columbia, Md.). The mixed dispersion was milled in LABSTAR laboratory media mill (Netzsch, Exton, Pa.) with 0.2 mm Toraycerum Yttria stabilized zirconia milling media. Small amount of samples were taken out periodically to monitor the milling progress. The dispersion samples were further diluted by MEK and the particle sizes were measured by Partica LA-950 Laser Diffraction Particle Size Distribution Analyzer (Horiba, Irvine, Calif.). The solid content measured by drying the dispersion in nitrogen purged oven at 65° C. was 32 wt % of the dispersion. The oxide content was 21.2 wt % of the dispersion.

### Preparatory Example 2: Tungsten Blue Oxide Dispersion

WO powder was combined with SOLSPERSE M389 and MEK, then processed and analyzed in the manner described in Example 1 to produce a dispersion.

### Preparatory Example 3: Coated Pellet Preparation

1500 g of LDPE-1 (Equistar NA21700) pellets were combined with 74 g concentrated Cesium Tungsten Oxide nanoparticle dispersion (obtained by rotary evaporation of 150 g Cesium Tungsten Oxide) in a polypropylene jar. Additional 22 g of Cesium Tungsten Oxide was further added to the jar (at its original concentration). The jar was sealed and put on a roller mill for 30 minutes, after which it was left in a nitrogen purged oven at 65° C. to remove the solvent. Polyethylene pellets coated with CWO were obtained and used further.

### Preparatory Example 4: Coated Pellet Preparation

1925 g of LDPE-1 (Equistar NA21700) pellets were combined with 250 g Tungsten oxide dispersion obtained in Example 1 in a polypropylene jar. The jar was sealed and put on a roller mill for 30 minutes, following which it was left in a nitrogen purged oven at 65° C. to remove the solvent. Polyethylene pellets coated with WO were obtained and used further.

### Preparatory Example 5: Coated Pellet Preparation

1500 g of LDPE-1 (Equistar NA21700) pellets were combined with 170 g of Cesium Tungsten Oxide in a polypropylene jar. The resulting mix was processed as in Preparatory Example 3.

### Preparatory Example 6: Coated Pellet Preparation

1000 g of LDPE-1 (Equistar NA21700) pellets were combined with 275 g WO dispersion obtained in Preparatory Example 2 in a polypropylene jar. The jar was sealed and put on a roller mill for 30 minutes, following which it was left in a nitrogen purged oven at 65° C. to remove the solvent. Polyethylene pellets coated with WO were obtained and used further.

### Film Extrusion

The backing material was produced by extruding a master-batch of pellets through a slotted die to produce a 100 micrometer thick and 8.9 cm wide film, where the master-batch was produced by combining varying amounts of LDPE pellets, LDPE pellets containing additives and coated LDPE pellets (in Preparatory Examples 3-6 as described above). Each blend was extruded through a Baker-Perkins 50 mm twin screw extruder at 3.8 cm/s at around 218° C. (425° F.) and a screw speed of 300 rpm. The compositions are shown in Table 1.

### Visible and IR Transmission Measurement

The transmission measurements were made on a Hunterlab UltraScan PRO spectrophotometer which meets CIE, ASTM and USP guidelines for accurate color measurement. The UltraScan PRO uses three Xenon flash lamps mounted in a reflective lamp housing as light source. The spectrophotometer is fitted with an integrating sphere accessory. This sphere is 152 mm (6 inches) in diameter and comports with ASTM E903, D1003, E308, et al. as published in “ASTM Standards on Color and Appearance Measurements,” Third Edition, ASTM, 1991. All samples were measured for percent transmission (with an aperture of 1.8 cm, or 0.7 inches). The spectra was measured in the range 350-1050 nm with 5 nm optical resolution and reporting intervals. HunterLab EasyMatch QC software was used in processing displaying, analyzing and reporting the spectral and color measurements. IR transmission (designated with a “T” superscript) at 1000 nm is tabulated in Table 1. For films which are opaque or mostly opaque reflectance measurement was carried out with the same spectrometer by placing the film sample at the reflectance port. IR reflectance (designated with an “R” superscript) for those samples at 1000 nm is tabulated in Table 1.

### Visible Light Transmission, Haze and Clarity Measurement

Visible light transmission, haze and clarity were measured using BYK-Hazegard Plus instrument available from BYK-Gardner USA, Columbia, Mo. The visible light transmission, Haze and Clarity are tabulated in Table 1 as (% T, % H and Clarity).

### Wide Angle Scattering Haze

Light is diffused in all directions causing a loss of contrast. ASTM D 1003-13 defines haze as that percentage of light which in passing through deviates from the incident beam greater than 2.5 degrees on the average.

### Narrow Angle Scattering See-Through Quality (Clarity)

Light is diffused in a small angle range with high concentration. This effect describes how well very fine details can be seen through the specimen. The see-through quality needs to be determined in an angle range smaller than 2.5 degrees. Measurement and analysis of haze and see-through quality guarantee a uniform and consistent product quality.

### Adhesive Coating

Backing films were first corona treated under nitrogen (1500 sccm N₂ at 12 m/min line speed with 500 W, 0.75 J/cm² energy density) following which a water-based acrylic pressure sensitive adhesive (PSA) coating was applied. Prior to coating the adhesive a primer layer was applied using a #8 Meyer rod onto the corona treated side of the backing film, and allowed to air dry. This was followed by applying a topcoat of the water-based acrylic PSA, at approximately a 25 micrometer thickness with a #24 Meyer rod and allowed to dry for 2 minutes in air.

### Materials for Laser Cutting Experiments:

1. Transparent Protective Tape
2. 304 Stainless Steel Shim with a thickness of 381 micrometers (0.015 in.) and width of 5.1 cm (2 in.) acquired from MCMASTER-CARR (Chicago, Ill.)

### Fiber Laser Cutting

A 400 W continuous wave fiber laser (SPI Lasers, UK) operating at a wavelength of 1070 nm was used to test performance of different tapes. An intense and high quality beam with M²=1.05 was generated by the laser. The fiber laser was protected from back reflection with a Faraday isolator mounted on the end of the beam delivery fiber. The output beam diameter was approximately 6 mm. The beam was directed to a commercially available welding head, acquired from Laser Mechanisms Inc. (Novi, Mich.). After being reflected down by a dichroic mirror, the beam was finally focused by a focusing lens with a focal length of 100 mm. The focal spot was approximately 40 micrometers. Additionally, nitrogen was used as the cutting assist gas.

A CCD camera mounted above the dichroic mirror allowed the operator to navigate around the edges of processed samples in a precise manner. The cutting system (i.e., the cutting head, camera and Faraday isolator) were mounted on a linear Z stage whereas the stainless steel samples were mounted on the top of precision X-Y stages, which enabled accurate motion during the cutting process.

For testing the laser cutting performance of extruded films 3M PHOTO MOUNT Adhesive was first sprayed on the film. The film was air dried for few minutes after which it was manually applied to a stainless steel (304 Stainless Steel, 380 micrometer thick) coupon. The stainless steel coupon and tape were then cut with the fiber laser at a power of 130 W and a speed of 80 mm/s.

### Comparative A: Commercially Available Product

Commercially available NOVACEL 4228REF Fiber laser protective tape was obtained. The tape appeared gray and opaque. No visible light transmission could be measured. For testing the laser cutting performance of the tape a piece of tape was applied by hand to a stainless steel (304 Stainless Steel, 380 micrometer thick) coupon. The stainless steel coupon and tape were then cut with the fiber laser at a power of 130 W and a speed of 80 mm/s.

### Comparative B: Carbon Black and TiO₂

A gray backing material was produced by extruding a master-batch of pellets through a slotted die to produce a 100 micrometer thick and 8.9 cm wide film, where the master-batch was produced by mixing 182 g LDPE-1, 18 g titanium dioxide (Standridge #11937) and 60 g Carbon Black. The final film construction contained approximately 0.5% Carbon Black and 5% Titanium Dioxide by weight.

For testing the laser cutting performance of extruded film 3M PHOTO MOUNT Adhesive was first sprayed on the film. The film was air dried for few minutes after which it was applied by hand to a stainless steel (304 Stainless Steel, 380 micrometer thick) coupon. The stainless steel coupon and tape were then cut with the fiber laser at a power of 130 W and a speed of 80 mm/s. The optical properties of the films were also measured on the adhesive sprayed film, (similar to one used for laser cutting). VLT, Visible light transmission (% T), haze (% H), clarity and Vis-IR transmission spectra were measured following the methods described above and the data is tabulated in Table 1. The tape was observed to absorb strongly both at 1 μm and also in the visible range.

### Comparative C: CWO and TiO₂

An opaque backing material was produced by extruding a master-batch of pellets through a slotted die to produce a 100 micrometer thick and 8.9 cm wide film, where the master-batch was produced by mixing 132 g LDPE-1, 18 g Titanium Dioxide and 100 g Cesium Tungsten Oxide (Preparatory Example 3). The final film construction contained approximately 1% Cesium Tungsten Oxide, and 5% Titanium Dioxide by weight.

Laser cutting performance and optical properties of the films were evaluated as described in Comparative B. CWO absorber predominantly absorbed in the near IR including at 1 μm and had high transmission in the visible range, however the inclusion of Titanium Dioxide, which has a high refractive index and strongly scatter both visible and IR light give the tape an opaque appearance and no measurable clarity; hence, inspection of the processed metal surfaces through the tape was impossible (Table 1).

### Comparative D: Talc, No Absorber

A transparent backing material was produced by extruding a master-batch of pellets through a slotted die to produce a 100 micrometer thick and 8.9 cm wide film, where the master-batch was produced by mixing 200 g LDPE-1 and 50 gram of Talc (ABC-5000PB). The final film construction contained approximately 10% Talc by weight.

Laser cutting performance and optical properties of the films were evaluated as described in Comparative B (Table 1). The LDPE film had high visible and IR transmission (1 μm). The talc particles have significantly lower refractive index than the Titanium Dioxide and are much closer to the refractive index of LDPE. The protective tapes loaded with Talc transparent have adequate visible transmission, haze and clarity to enable inspection of the processed metal surfaces through the tape.

### Comparative E: DTE, No Absorber

A transparent backing material was produced by extruding a master-batch of pellets through a slotted die to produce a 100 micrometer thick and 8.9 cm wide film, where the master-batch was produced by mixing 200 g LDPE-1 and 50 g Diatomaceous Earth (DTE) (ABC-5000). The final film construction contained approximately 10% DTE by weight.

Laser cutting performance and optical properties of the films were evaluated as described in Comparative B (Table 1). The LDPE film had high visible and IR transmission (1 μm). DTE has a refractive index significantly lower than Titanium Dioxide and much closer to the refractive index of LDPE. The protective tapes loaded with DTE are transparent and have adequate visible transmission, haze and clarity to enable inspection of the processed metal surfaces through the tape.

### Example 1: WO (Low Concentration) and Talc

A transparent backing material was produced by extruding a master-batch of pellets through a slotted die to produce a 100 micrometer thick and 8.9 cm wide film, where the master-batch was produced by mixing 150 g LDPE-1 pellets, 75 g Tungsten Oxide pellets (Preparative Example 4) and 25 g Talc pellets (ABC-5000PB). The final film construction contained approximately 0.75% Tungsten Oxide, and 5% Talc by weight.

Laser cutting performance and optical properties of the films were evaluated as described in Comparative B (Table 1). The LDPE film containing WO and Talc had high visible transmission but moderate IR transmission (moderate IR absorption) (1 μm). The Talc particles had significantly lower refractive index than titanium dioxide particles and are much closer to the refractive index of LDPE. The protective tapes loaded with tungsten oxide and talc had adequate visible transmission, haze and clarity to enable inspection of the processed metal surfaces through the tape.

### Example 2: WO (High Concentration) and Talc

A transparent backing material was produced by extruding a master-batch of pellets through a slotted die to produce a 100 micrometer thick and 8.9 cm wide film, where the master-batch was produced by mixing 75 g LDPE pellets (LDPE-1), 150 g Tungsten Oxide pellets (Preparative Example 4) and 25 g Talc pellets (ABC-5000PB). The final film construction contained approximately 1.5% Tungsten Oxide, and 5% Talc by weight.

Laser cutting performance and the optical properties of the films were evaluated as described in Comparative B (Table 1). The LDPE film containing WO and talc had high visible transmission but low IR transmission (strong IR absorption) (1 micrometer). The refractive index of Talc is significantly lower than Titanium Dioxide and is much closer to the refractive index of LDPE. The protective tapes loaded with tungsten oxide and talc had adequate visible transmission, haze and clarity to enable inspection of the processed metal surfaces through the tape. In addition, the tapes had adequate IR absorption to enable good laser cut performance.

### Example 3: WO and DTE (Low Concentration)

A transparent backing material was produced by extruding a master-batch of pellets through a slotted die to produce a 100 micrometer thick and 8.9 cm wide film, where the master-batch was produced by mixing 75 g LDPE-1 pellets, 150 g Tungsten Oxide pellets (Preparative Example 4) and 50 g DTE pellets (ABC-5000. The final film construction contained approximately 1.5% Tungsten Oxide, and 5% DTE by weight.

Laser cutting performance was evaluated as described in Comparative B. The optical properties of the films were measured similarly to that described in Comparative B (Table 1). The LDPE film containing WO and DTE had high visible transmission but low IR transmission (strong IR absorption) (1 μm). The DTE particles have significantly lower refractive index than titanium dioxide particles and are much closer to the refractive index of LDPE. The protective tapes loaded with tungsten oxide and DTE have adequate visible transmission, haze and clarity to enable inspection of the processed metal surfaces through the tape. In addition the tapes have adequate IR absorption to enable good laser cut performance.

### Example 4: WO and DTE (High Concentration)

A transparent backing material was produced by extruding a master-batch of pellets through a slotted die to produce a 100 micrometer thick and 8.9 cm wide film, where the master-batch was produced by mixing 50 g LDPE-1 pellets, 150 g Tungsten Oxide pellets (Preparative Example 4) and 50 grams DTE (ABC-5000) pellets. The final film construction contained approximately 1.5% WO, and 10% DTE by weight.

Laser cutting performance was evaluated as described in Comparative B. The optical properties of the films were measured similarly to that described in Comparative B (Table 1). The LDPE film containing WO and DTE had high visible transmission but low IR transmission (strong IR absorption) (1 μm). The DTE particles have significantly lower refractive index than titanium dioxide particles and are much closer to the refractive index of LDPE. The protective tapes loaded with tungsten oxide and DTE have adequate visible transmission, haze and clarity to enable inspection of the processed metal surfaces through the tape. In addition the tapes have adequate IR absorption to enable good laser cut performance.

### Comparative F: WO and DTE (High Concentration)

An opaque backing material was produced by extruding a master-batch of pellets through a slotted die to produce a 100 micrometer thick and 8.9 cm wide film, where the master-batch was produced by mixing 82 g LDPE-1 pellets, 18 g Titanium Dioxide pellets (Standridge #11937) and 150 g WO pellets (Preparative Example 5). The final film construction contained approximately 1.5% Tungsten Oxide, and 5% Titanium Dioxide by weight.

Laser cutting performance and optical properties of the films were evaluated as described in Comparative B. WO absorber predominantly absorbs in the near IR including at 1 μm and had high transmission in the visible range, however the inclusion of titanium dioxide (TiO₂) particles, which have high refractive index and strongly scatter both visible and IR light give the tape an opaque appearance and no measurable clarity, hence inspection of the processed metal surfaces through the tape impossible (Table 1), even though good laser cut performance can be obtained.

### Example 5: WO and TiO₂ (Low Concentration)

A transparent backing material was produced by extruding a master-batch of pellets through a slotted die to produce a 100 micrometer thick and 8.9 cm wide film, where the master-batch was produced by mixing 146 g of LDPE-1 pellets, 100 g Tungsten Oxide pellets (Preparative Example 5) and 4 g Titanium Dioxide pellets (Standridge #11937) pellets. The final film construction contained approximately 1.5% Tungsten Oxide, and 1% TiO₂ by weight.

The optical properties of the films were measured similarly to that described in Comparative B (Table 1). The LDPE film containing WO and TiO₂ had low visible and IR transmission (strong IR absorption) (1 μm). The TiO₂ particles had high refractive index and strongly scattered both visible and IR light, giving the tape a white appearance. The loading of TiO₂ was small enough, however, to achieve adequate visible transmission, haze and clarity to enable inspection of the processed metal surfaces through the tape. The laser cut performance was not evaluated. It was possible to increase the tungsten oxide content while still maintaining the high visible transmission and clarity and obtain a good laser cutting performance as long as TiO₂ content can be maintained at low levels.

### Example 6: WO Only

A transparent backing material was produced by extruding a master-batch of pellets through a slotted die to produce a 100 micrometer thick and 8.9 cm wide film, where the master-batch was produced by mixing 100 g LDPE-1 pellets and 150 g Tungsten Oxide pellets (Preparative Example 5). The final film construction contained approximately 1.5% Tungsten Oxide.

Laser cutting performance was evaluated as described in Comparative B. The optical properties of the films were measured similarly to that described in Comparative B (Table 1). The LDPE film containing WO had high visible transmission but low IR transmission (strong IR absorption) (1 μm). The protective tapes loaded with WO had adequate visible transmission, haze and clarity to enable inspection of the processed metal surfaces through the tape.

In Table 1, a rating of “good” for cutting performance means that the laser system was able to cut through the sample at 80 mm/s. A rating of “poor” means that the laser system was only able to make a partial cut or could not cut at all at 80 mm/s. The term “opaque” means that no clarity could be measured due to high haze and/or low transmission.

TABLE 1
Compositions of Adhesive-backed Laser Films

| | | | Absorber | Synergist | | | | | |
|---|---|---|---|---|---|---|---|---|---|
| Example/ | Absorber | Synergist | Concentration | Concentration | % T | | | IR | Cutting |
| Comparative | Type | Type | [%] | [%] | (VLT) | % H | Clarity | 1 μm | Performance |
| COMP. A | Novacel 4228REF, commercial tape | | | | Opaque | | | | |
| COMP. B | Carbon | TiO₂ | 0.5 | 5 | Opaque | | | 25^{R} | Good |
| | Black | | | | | | | | |
| COMP. C | CWO | TiO₂ | 1 | 5 | 18.7 | 102 | Opaque | 22^{R} | Good |
| COMP. D | None | Talc | 0 | 10 | 88.6 | 69.3 | 18.4 | 86^{T} | Poor |
| COMP. E | None | DTE | 0 | 10 | 75.6 | 84.5 | 68.8 | 87^{T} | Poor |
| EX. 1 | WO | Talc | 0.75 | 5 | 68.4 | 68.0 | 19.0 | 44^{T} | Poor |
| EX. 2 | WO | Talc | 1.5 | 5 | 58.4 | 73.4 | 24.3 | 34^{T} | Good |
| EX. 3 | WO | DTE | 1.5 | 5 | 69.9 | 69.0 | 21.7 | 53^{T} | Good |
| EX. 4 | WO | DTE | 1.5 | 10 | 57.2 | 84.2 | 15.4 | 35^{T} | Good |
| COMP. F | WO | TiO₂ | 1.5 | 5 | 4.8 | 102 | Opaque | 19^{R} | Good |
| EX. 5 | WO | TiO₂ | 1.5 | 1 | 56.8 | 94.5 | 92.8 | 20^{R} | Not evaluated |
| EX. 6 | WO | Talc | 1.5 | No | 69.1 | 64.5 | 24.3 | 50^{T} | Poor |

All cited references, patents, and patent applications in the above application for letters patent are herein incorporated by reference in their entirety in a consistent manner. In the event of inconsistencies or contradictions between portions of the incorporated references and this application, the information in the preceding description shall control. The preceding description, given in order to enable one of ordinary skill in the art to practice the claimed disclosure, is not to be construed as limiting the scope of the disclosure, which is defined by the claims and all equivalents thereto.

1. An adhesive-backed film comprising:
a base layer comprising a polymer and having opposing first and second major surfaces; and
an adhesive layer comprising a pressure-sensitive adhesive disposed on the second major surface of the base layer; and
an infrared absorber comprising a metal-doped tungsten oxide or a reduced tungsten oxide that is present in one or both of the polymer in the base layer and the pressure-sensitive adhesive in the adhesive layer,
wherein either the base layer or the adhesive layer further comprises a synergistic filler having a refractive index of up to 2, the synergistic filler comprising one of more of talc, diatomaceous earth, metal carbonate, glass bead, synthetic ceramic bead, natural clays, and synthetic clays and
wherein the adhesive-backed film is sufficiently transparent to provide contact clarity with respect to a surface having the adhesive-backed film disposed thereon.

2. The adhesive-backed film of claim 1, wherein the infrared absorber is a near-infrared absorber.

3. (canceled)

4. The adhesive-backed film of claim 1, wherein the metal-doped tungsten oxide comprises one or more of cesium tungsten oxide, sodium tungsten oxide, antimony tin oxide, and indium tin oxide.

5. The adhesive-backed film of claim 2, wherein the near-infrared absorber comprises a near-infrared absorbing dye or near-infrared absorbing pigment.

6. The adhesive-backed film of claim 1, wherein the infrared absorber displays an absorption of at least 20% at a wavelength of from 780 nm to 1300 nm along the thickness dimension of the adhesive-backed film.

7. The adhesive-backed film of claim 1, wherein the infrared absorber is present in an amount of from 0.1 percent to 10 percent by volume relative to the overall volume of the base layer and the adhesive layer.

8. (canceled)

9. (canceled)

10. The adhesive-backed film of claim 1, wherein the synergistic filler is present in an amount of from 0.5 percent to 30 percent by volume relative to the overall volume of the base layer and the adhesive layer.

11. The adhesive-backed film of claim 1, wherein the synergistic filler is present in the base layer and the refractive index differs from that of the polymer by up to 0.8.

12. A laminated substrate comprising a substrate and the adhesive-backed film of claim 1 at least partially adhered to the substrate.

13. (canceled)

14. A method of laser cutting a substrate comprising:
adhering to an outer surface of the substrate an adhesive-backed film of claim 1 to provide a laminated substrate; and
directing an infrared laser beam onto the laminated substrate to cut along at least a portion of the outer surface whereby the laser beam causes areas of the adhesive-backed film extending over the outer surface to shrink away and/or become removed from the edges of the cut by a certain margin.

15. The method of claim 14, wherein directing the infrared laser beam onto the laminated substrate causes areas of the adhesive-backed film to be spaced away from the cut by a margin width of at least 20 micrometers along the outer surface.
